(19) United States
(12) Patent Application Publication
(10) Pub. No.: US 2026/0362579 A1
(43) Pub. Date: Nov. 12, 2026

(54) EXTREME ULTRAVIOLET LIGHT GENERATION APPARATUS, DROPLET GENERATION CONTROL METHOD, AND ELECTRONIC DEVICE MANUFACTURING METHOD

(71) Applicant: Gigaphoton Inc., Tochigi (JP)

(72) Inventors: Shogo KITASAKA, Oyama-shi (JP); Yuichi NISHIMURA, Oyama-shi (JP); Hiroki SUZUKI, Oyama-shi (JP)

(73) Assignee: Gigaphoton Inc., Tochigi (JP)

(21) Appl. No.: 19/643,540

(22) Filed: Apr. 9, 2026

(30) Foreign Application Priority Data
May 9, 2025 (JP) 2025-078899

(51) Int. Cl. H05G 2/00

(52) U.S. Cl. CPC H05G 2/0027; H05G 2/0023; H05G 2/0084

(57) ABSTRACT

An extreme ultraviolet light generation apparatus generating extreme ultraviolet light by irradiating droplets with laser light includes a tank storing a liquid target substance; a nozzle outputting the target substance; a piezoelectric element applying vibration, reflecting an electric signal having a ratio of an on time in one cycle as a duty, to the target substance to be output from the nozzle to generate the droplets; a timing sensor measuring a temporal passage interval of the droplets; and a processor outputting the electric signal to the piezoelectric element after setting the duty, calculating a droplet parameter from the passage interval, determining a prohibited duty that is the duty prohibited to be set based on data in which the duty and the droplet parameter are associated with each other, and performing control of setting the duty of the electric signal based on the droplet parameter while avoiding the prohibited duty.

### CROSS-REFERENCE TO RELATED APPLICATIONS

The present application claims the benefit of Japanese Patent Application No. 2025-078899, filed on May 9, 2025, the entire contents of which are hereby incorporated by reference.

### BACKGROUND

### 1. Technical Field

The present disclosure relates to an extreme ultraviolet light generation apparatus, a droplet generation control method, and an electronic device manufacturing method.

### 2. Related Art

Recently, miniaturization of a transfer pattern in optical lithography of a semiconductor process has been rapidly proceeding along with miniaturization of the semiconductor process. In the next generation, microfabrication at 10 nm or less will be required. Therefore, it is expected to develop a semiconductor exposure apparatus that combines an generating extreme apparatus for ultraviolet (EUV) light having a wavelength of about 13 nm with a reduced projection reflection optical system. As the EUV light generation apparatus, a laser produced plasma (LPP) type apparatus using plasma generated by irradiating a target substance with laser light has been developed.

### LIST OF DOCUMENTS

### Patent Documents

Patent Document 1: U.S. Pat. No. 10,225,917
Patent Document 2: U.S. Pat. No. 10,369,596
Patent Document 3: Japanese Patent Application Publication No. 2002-221281

### SUMMARY

An extreme ultraviolet light generation apparatus according to an aspect of the present disclosure is configured to generate extreme ultraviolet light by irradiating droplets with laser light. The extreme ultraviolet light generation apparatus includes a tank configured to store a target substance in a liquid state; a nozzle configured to output the target substance stored in the tank; a piezoelectric element configured to apply vibration to the target substance to be output from the nozzle to generate the droplets of the target substance, the vibration reflecting an electric signal having a ratio of an on time in one cycle as a duty; a timing sensor configured to measure a temporal passage interval of the droplets; and a processor configured to output the electric signal to the piezoelectric element after setting the duty, calculate a droplet parameter from the passage interval, determine a prohibited duty that is the duty prohibited to be set based on data in which the duty and the droplet parameter with the duty are associated with each other, and perform control of setting the duty of the electric signal based on the droplet parameter while avoiding the prohibited duty.

A droplet generation control method according to an aspect of the present disclosure in a method in an extreme ultraviolet light generation apparatus configured to generate extreme ultraviolet light by irradiating droplets with laser light. The method includes setting a duty representing a ratio of an on time in one cycle of an electric signal, generating the droplets of a target substance by applying vibration reflecting the electric signal to the target substance to be output from a nozzle by applying the electric signal to a piezoelectric element, measuring a temporal passage interval of the droplets by a timing sensor, calculating a droplet parameter from the passage interval, determining a prohibited duty that is the duty prohibited to be set based on data in which the duty and the droplet parameter with the duty are associated with each other, and performing control of setting the duty of the electric signal based on the droplet parameter while avoiding the prohibited duty.

An electronic device manufacturing method according to an aspect of the present disclosure includes generating extreme ultraviolet light using an extreme ultraviolet light generation apparatus, outputting the extreme ultraviolet light to an exposure apparatus, and exposing a photosensitive substrate to the extreme ultraviolet light in the exposure apparatus to manufacture an electronic device. Here, the extreme ultraviolet light generation apparatus includes a tank configured to store a target substance in a liquid state; a nozzle configured to output the target substance stored in the tank; a piezoelectric element configured to apply vibration to the target substance to be output from the nozzle to generate the droplets of the target substance, the vibration reflecting an electric signal having a ratio of an on time in one cycle as a duty; a timing sensor configured to measure a temporal passage interval of the droplets; and a processor configured to output the electric signal to the piezoelectric element after setting the duty, calculate a droplet parameter from the passage interval, determine a prohibited duty that is the duty prohibited to be set based on data in which the duty and the droplet parameter with the duty are associated with each other, and perform control of setting the duty of the electric signal based on the droplet parameter while avoiding the prohibited duty.

An electronic device manufacturing method according to an aspect of the present disclosure includes generating extreme ultraviolet light using an extreme ultraviolet light generation apparatus, inspecting a defect of a mask by irradiating the mask with the extreme ultraviolet light, selecting a mask using a result of the inspection; and exposing and transferring a pattern formed on the selected mask onto a photosensitive substrate. Here, the extreme ultraviolet light generation apparatus includes a tank configured to store a target substance in a liquid state; a nozzle configured to output the target substance stored in the tank; a piezoelectric element configured to apply vibration to the target substance to be output from the nozzle to generate the droplets of the target substance, the vibration reflecting an electric signal having a ratio of an on time in one cycle as a duty; a timing sensor configured to measure a temporal passage interval of the droplets; and a processor configured to output the electric signal to the piezoelectric element after setting the duty, calculate a droplet parameter from the passage interval, determine a prohibited duty that is the duty prohibited to be set based on data in which the duty and the droplet parameter with the duty are associated with each other, and perform control of setting the duty of the electric signal based on the droplet parameter while avoiding the prohibited duty.

### BRIEF DESCRIPTION OF THE DRAWINGS

Embodiments of the present disclosure will be described below merely as examples with reference to the accompanying drawings.

FIG. 1 is a schematic diagram showing the configuration for measuring a droplet passage interval.

FIG. 2 is a schematic diagram of an output signal of a light receiving element of a droplet detection sensor.

FIG. 3 is a diagram showing an example of an electric signal to be applied to a piezoelectric element.

FIG. 4 is a diagram schematically showing a configuration example of an LPP EUV light generation system according to a comparative example.

FIG. 5 is a flowchart showing main flow of operation of an EUV light generation apparatus.

FIG. 6 is a flowchart showing an example of a subroutine of DL combining adjustment applied to step S3 in FIG. 5.

FIG. 7 is a graph showing an example of a DL passage interval σ measured in the DL combining adjustment.

FIG. 8 is a flowchart showing an example of a subroutine of DL combining control applied to step S4 in FIG. 5.

FIG. 9 is a graph for explaining a process of changing a Duty in a performance improving direction.

FIG. 10 is a graph showing an example of change in the DL passage interval σ and the Duty with respect to control time in the DL combining control.

FIG. 11 is an explanatory diagram showing a problem of operation H setting a piezoelectric Duty causing deterioration of the DL passage interval σ in a search process of the DL combining control.

FIG. 12 is a graph comparing EUV energies in a case in which the DL passage interval σ is favorable and a case in which the DL passage interval σ is deteriorated.

FIG. 13 is a flowchart showing an example of a DL combining adjustment subroutine applied to the EUV light generation apparatus according to a first embodiment.

FIG. 14 is an explanatory diagram showing an example of a prohibited Duty stored based on a measurement result of the DL passage interval σ.

FIG. 15 is a flowchart showing an example of a DL combining control subroutine applied to the EUV light generation apparatus according to the first embodiment.

FIG. 16 is a conceptual diagram of operation in which setting to a prohibited Duty or a piezoelectric Duty that crosses a prohibited Duty is prohibited.

FIG. 17 is a flowchart showing an example of the DL combining control subroutine applied to the EUV light generation apparatus according to a modification of the first embodiment.

FIG. 18 is an explanatory diagram of a combining failure rate.

FIG. 19 is a flowchart showing an example of the DL combining adjustment subroutine applied to the EUV light generation apparatus according to a second embodiment.

FIG. 20 is an explanatory diagram showing an example of the prohibited Duty stored based on a measurement result of the combining failure rate.

FIG. 21 is a flowchart showing an example of the DL combining control subroutine applied to the EUV light generation apparatus according to the second embodiment.

FIG. 22 is a conceptual diagram of operation in which setting to a prohibited Duty or a piezoelectric Duty that crosses the prohibited Duty is prohibited.

FIG. 23 is a flowchart showing an example of the DL combining control subroutine applied to the EUV light generation apparatus according to a modification of the second embodiment.

FIG. 24 is a diagram showing schematically the configuration of an exposure apparatus connected to the EUV light generation apparatus.

FIG. 25 is a diagram schematically showing the configuration of an inspection apparatus connected to the EUV light generation apparatus.

### DESCRIPTION OF EMBODIMENTS

### <Contents>

1. Description of terms
   1.1 DL passage interval σ
   1.2 Duty
2. Outline of EUV light generation system according to comparative example
   2.1 Configuration
   2.2 Operation
      2.2.1 Example of DL combining adjustment
      2.2.2 Example of DL combining control
   2.3 Problem
3. First Embodiment
   3.1 Configuration
   3.2 Operation
      3.2.1 Example of DL combining adjustment
      3.2.2 Example of DL combining control
   3.3 Effect
   3.4 Modification
      3.4.1 Configuration
      3.4.2 Operation
      3.4.3 Effect
4. Second Embodiment
   4.1 Configuration
   4.2 Operation
      4.2.1 Example of DL combining adjustment
      4.2.2 Example of DL combining control
   4.3 Effect
   4.4 Modification
      4.4.1 Configuration
      4.4.2 Operation
      4.4.3 Effect
5. Electronic device manufacturing method
6. Processor
7. Others

Hereinafter, embodiments of the present disclosure will be described in detail with reference to the drawings. The embodiments described below show some examples of the present disclosure and do not limit the contents of the present disclosure. Also, all configurations and operation described in the embodiments are not necessarily essential as configurations and operation of the present disclosure. Here, the same components are denoted by the same reference numeral, and duplicate description thereof is omitted.

### 1. Description of Terms

1.1 DL passage interval σ

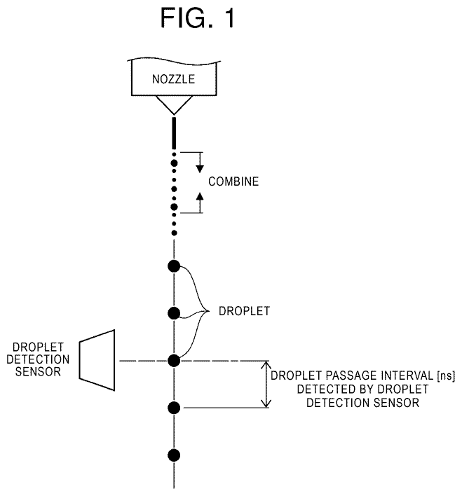

FIG. 1 is a schematic diagram showing the configuration for measuring a droplet passage interval σ being a time interval of droplet passage. FIG. 1 shows a nozzle that ejects a target substance, droplets formed by the target substances ejected from the nozzle, and a droplet detection sensor being a timing sensor that detects a timing at which the droplet passes. The droplet detection sensor is arranged facing a position through which the droplet passes. The droplet detection sensor includes a light receiving element (not shown), and detects a change in the output voltage of the light receiving element caused by passage of the droplet. A light emission trigger detection threshold value for light emission trigger of a pulse laser device is set for the voltage of the light receiving element. The droplet detection sensor may include an illumination light source (not shown) for illuminating the droplet.

A “droplet” is a form of a target supplied into a chamber. The droplet may refer to a droplet-shaped target having a substantially spherical shape due to surface tension of a molten target substance. In the present specification and drawings, the expression “DL” is an abbreviation of a “droplet”.

The jet of the target substance ejected from the nozzle is separated into droplets, and a plurality of droplets is combined to form a DL. The normally-output DL obtained by combining a specified number of droplets creates a relatively large shadow. Therefore, when the normally-output DL passes beside the droplet detection sensor, the voltage of the light receiving element is greatly reduced. As a result, the voltage of the light receiving element falls below the light emission trigger detection threshold value, causing a trigger start point of the pulse laser device.

On the other hand, depending on DL generation conditions, the DL having insufficient combining number and the droplet having no combining occur. Although the shadow due to the DL with combining failure is small and the voltage drop of the light receiving element is small, the voltage of the light receiving element may fall below the light emission trigger detection threshold value to cause the trigger start point of the pulse laser device.

In order to avoid such an event, the DL generation condition is determined using a detection interval (hereinafter, referred to as a “DL passage interval”) of a signal indicating the voltage of the light receiving element falling below the light emission trigger detection threshold value as an index. Since the DL passage interval becomes a predetermined DL generation cycle when DL combining is normal, the DL combining is evaluated by an index of a DL passage interval variation o calculated by Expression 1 below.

$$DL passage interval σ = \sqrt{\frac{1}{n} {\sum }_{i = 1}^{n} {( Ii - Iave )}^{2}} \qquad [ Expression 1 ]$$

In Expression 1, n is the number of calculation samples, Ii is the i-th DL passage interval, and Iave is the average of the DL passage intervals for the number of calculation samples. Hereinafter, the DL passage interval variation o is referred to as a “DL passage interval σ”. The unit of the DL passage interval σ is, for example, nanosecond [ns]. The DL passage interval σ is an example of the “droplet parameter” in the present disclosure. A parameter related to the droplet is referred to as a “droplet parameter”.

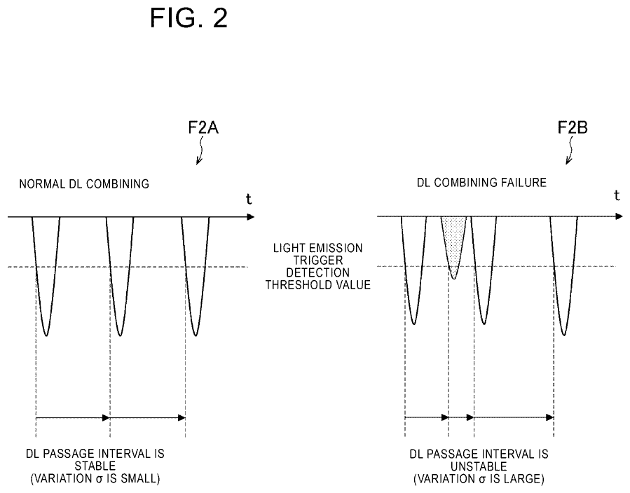

FIG. 2 is a schematic diagram of an output signal (passage timing signal) of the light receiving element of the droplet detection sensor. In FIG. 2, the horizontal axis represents time, and the vertical axis represents, for example, a voltage. F2A on the left side of FIG. 2 shows a case in which the DL passage interval is stable. Further, F2B on the right side of FIG. 2 shows a case in which the DL passage interval is unstable. When the DL combining is normal, the DL passage interval is stable and the DL passage interval σ is small, as shown in F2A on the left side. On the other hand, when the DL combining is defective, the DL passage interval becomes unstable and the DL passage interval σ is large, as shown in F2B on the right side.

### 1.2 Duty

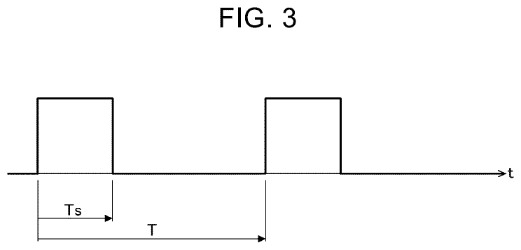

FIG. 3 is a diagram showing an example of an electric signal to be applied to a piezoelectric element for generating a droplet. FIG. 3 shows an example of a rectangular wave having a predetermined cycle. In FIG. 3, the horizontal axis represents time, and the vertical axis represents the voltage. “Duty” is a ratio [%] of an on time (high potential voltage time) Ts in one rectangular wave cycle T.

### 2. Outline of EUV Light Generation System According to Comparative Example

### 2.1 Configuration

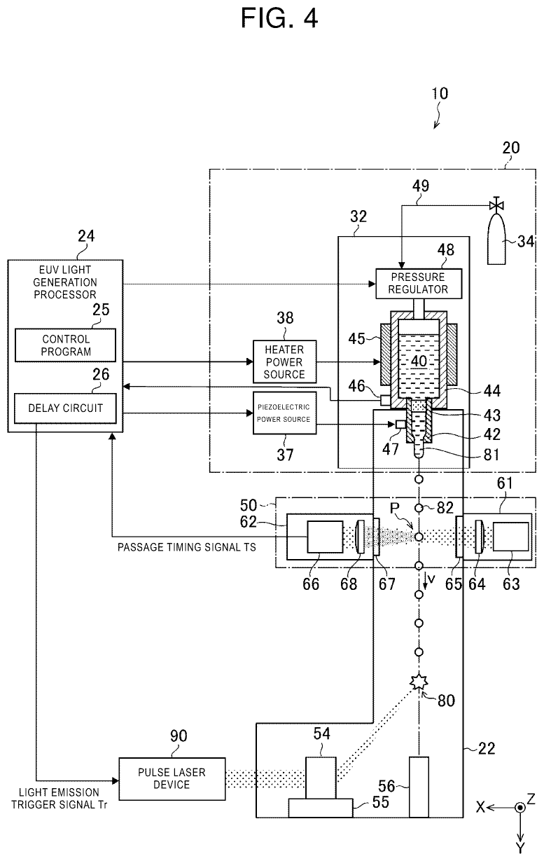

FIG. 4 is a diagram schematically a showing configuration example of an LPP EUV light generation system according to a comparative example. The comparative example of the present disclosure is an example recognized by the applicant as known only by the applicant, and is not a publicly known example admitted by the applicant. The expression “EUV light” is an abbreviation for “extreme ultraviolet light”.

The EUV light generation apparatus 10 includes a target generation system 20, a chamber 22, an EUV light generation processor 24, and a droplet detection device 50. The EUV light generation apparatus 10 is used together with a pulse laser device 90. In the present disclosure, a system including the EUV light generation apparatus 10 and the pulse laser device 90 is referred to as the EUV light generation system.

The target generation system 20 includes a target supply unit 32, an inert gas supply unit 34, a piezoelectric power source 37, and a heater power source 38.

The target supply unit 32 includes a nozzle 42 having a hole for outputting a molten target substance 40, a filter 43, a tank 44 for storing the target substance 40, a heater 45, a temperature sensor 46, a piezoelectric element 47, and a pressure regulator 48.

The nozzle 42 corresponds to the nozzle shown in FIG. 1. The filter 43 is arranged upstream of the nozzle 42 and removes impurities contained in the target substance 40. The target substance 40 is, for example, tin (Sn). The nozzle 42, the heater 45, and the temperature sensor 46 are fixed to the tank 44. The piezoelectric element 47 is fixed to the nozzle 42.

The pressure regulator 48 is arranged at a pipe 49 between the inert gas supply unit 34 and the tank 44. An inert gas supplied from the inert gas supply unit 34 may be, for example, an Ar gas or an He gas.

The target substance 40 in the tank 44 is output as a jet 81 from the nozzle 42 owing to the pressure difference between the pressure of the inert gas supplied from the pressure regulator 48 and the pressure in the chamber 22. When vibration is applied to the nozzle 42 by the piezoelectric element 47, the jet 81 output from the nozzle 42 is separated into droplet forms to form a droplet 82 (hereinafter, referred to as the DL 82).

The chamber 22 includes a droplet detection device 50, a laser light concentrating optical system 54, a two-axis stage 55, and a target collection unit 56.

The droplet detection device 50 (hereinafter, referred to as the DL detection device 50) corresponds to the droplet detection sensor shown in FIG. 1. The DL detection device 50 includes a light source unit 61 and a light receiving unit 62. The light source unit 61 includes a CW laser 63 which is a light source, an illumination optical system 64 which is a light concentrating lens, and a window 65. The light source unit 61 is arranged so as to illuminate the DL 82 at a predetermined position P on a target trajectory between the nozzle 42 of the target supply unit 32 and a plasma generation region 80.

The light receiving unit 62 includes an optical sensor 66 which is a light receiving element, and a window 67 and a light receiving optical system 68 for introducing CW laser light to the optical sensor 66. The light receiving unit 62 is arranged so as to receive the CW laser light output from the light source unit 61. When the DL 82 blocks the CW laser light, the output of the optical sensor 66 decreases. That is, when the DL 82 passes through the position P and the voltage drops, the light receiving unit 62 outputs a passage timing signal TS. The passage timing signal TS is a signal indicating a timing at which the DL 82 has passed through the position P. The passage timing signal TS output from the DL detection device is input to the EUV light generation processor 24. On the basis of the passage timing signal TS obtained from the DL detection device 50, it is possible to measure the temporal passage interval of the DL 82 passing through the position P.

The EUV light generation processor 24 includes a control program 25 and a delay circuit 26. The passage timing signal TS is input to the delay circuit 26 via the EUV light generation processor 24. The EUV light generation processor 24 sets a delay time of the delay circuit 26. The EUV light generation processor 24 may be connected to the delay circuit 26 via a signal line for setting the delay time of the delay circuit 26. Here, the delay circuit 26 may be configured separately from the EUV light generation processor 24 or may be configured as a part of the EUV light generation processor 24.

The delay circuit 26 adds the delay time to the passage timing signal TS to generate a light emission trigger signal Tr. The light emission trigger signal Tr output from the delay circuit 26 is input to the pulse laser device 90.

The pulse laser device 90 outputs pulse laser light based on the light emission trigger signal Tr. The pulse laser device 90 may be, for example, a CO₂ laser device. Further, the pulse laser device 90 may be a solid-state laser device in which a crystal obtained by doping any one of YVO₄ (yttrium-vanadium oxide), YLF (yttrium-lithium fluoride), and YAG (yttrium-aluminum-garnet) with an impurity is used as a laser medium.

The laser light concentrating optical system 54 is an optical system that concentrates the pulse laser light output from the laser device 90 and introduced into the chamber 22 on the plasma generation region 80. The laser light concentrating optical system 54 is supported by the two-axis stage 55. The two-axis stage 55 can move the laser light concentrating optical system 54 in two axis directions of a first axis direction and a second axis direction. For example, the first axis direction may be a Z-axis direction, and the second axis direction may be a Y-axis direction.

In the present specification, the direction in which the EUV light is output from the chamber 22 of the EUV light generation apparatus 10 toward an external apparatus such as an exposure apparatus (not shown) is defined as the Z-axis direction. An X-axis direction and the Y-axis direction are orthogonal to the Z-axis direction and orthogonal to each other, and the target travel direction in which the DL 82 output from the nozzle 42 travels toward the plasma generation region 80, that is, the direction of the trajectory of the DL 82 is defined as the Y-axis direction. In the subsequent drawings, the same coordinate system as that introduced in FIG. 4 is used.

By adjusting the position of the laser light concentrating optical system 54 by the two-axis stage 55, it is possible to adjust the concentration position of the pulse laser light into the plasma generation region 80. The laser light concentrating optical system 54 may include a plurality of optical elements.

The target collection unit 56 is arranged on the trajectory of the DL 82, and collects the DL 82 which has not been irradiated with the pulse laser light.

Further, an EUV light concentrating mirror (not shown) is arranged in the chamber 22. The EUV light concentrating mirror has a spheroidal reflection surface. A multilayer reflection film n in which molybdenum and silicon are alternately laminated is formed on the reflection surface of the EUV light concentrating mirror. The EUV light concentrating mirror has a first focal point and a second focal point and is positioned such that the first focal point is located in the plasma generation region 80. The EUV light concentrating mirror selectively reflects EUV light from among the radiation light that is radiated from plasma generated at the plasma generation region 80. The EUV light concentrating mirror concentrates the selectively reflected EUV light on the second focal point (intermediate focal point). An aperture (not shown) is arranged at the intermediate focal point, and the EUV light having passed through the aperture enters the external apparatus.

### 2.2 Operation

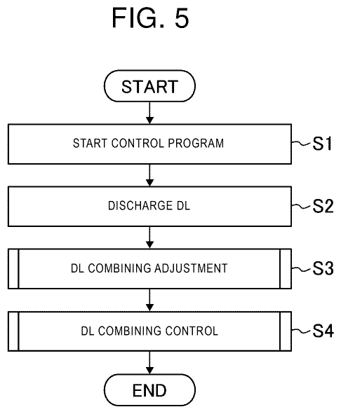

FIG. 5 is a flowchart showing main flow of operation of the EUV light generation apparatus 10. In step S1, the EUV light generation processor 24 executes the control program 25 when EUV light generation command is ordered from an operator or an external apparatus (not shown). When the EUV light generation processor 24 starts executing the control program 25, the DL 82 is discharged from the target supply unit 32 in step S2.

In step S2, the EUV light generation processor 24 controls the heater power source 38 based on a detection value of the temperature sensor 46 so that the temperature of Sn in the target supply unit 32 becomes equal to or higher than the melting point and to melt Sn stored in the tank 44. For example, the EUV light generation processor 24 controls the heater power source 38 so that Sn in the target supply unit 32 becomes a predetermined temperature of 232 °C to 300 °C. The EUV light generation processor 24 also controls the inert gas to a predetermined pressure by the pressure regulator 48, for example, the pressure of 0.2 MPa to 40 MPa, to output the liquid Sn inside the tank 44 to the outside of the nozzle 42.

The EUV light generation processor 24 vibrates the nozzle 42 so that the jet 81 of the liquid Sn output from the nozzle 42 is turned into droplets and a plurality of droplets are combined to generate a combined DL having a predetermined diameter at a predetermined cycle. For example, the EUV light generation processor 24 applies a voltage waveform of a rectangular wave having a predetermined frequency and a predetermined Duty to the piezoelectric element 47 via the piezoelectric power source 37, and causes the nozzle 42 to vibrate at a predetermined frequency. The piezoelectric element 47 is an example of a vibration element that applies vibration to the liquid target substance 40.

Hereinafter, the term “DL” in the case of generating a DL or generation of a DL in the present specification refers to a combined DL unless otherwise specified. In the present specification, the Duty of the voltage waveform of the rectangular wave applied to the piezoelectric element 47 is referred to as “Duty for the piezoelectric element 47”, “piezoelectric Duty”, or simply “Duty”. The Duty is one of vibration parameters related to the vibration of the piezoelectric element 47, and the value of the Duty is referred to as a “Duty value”.

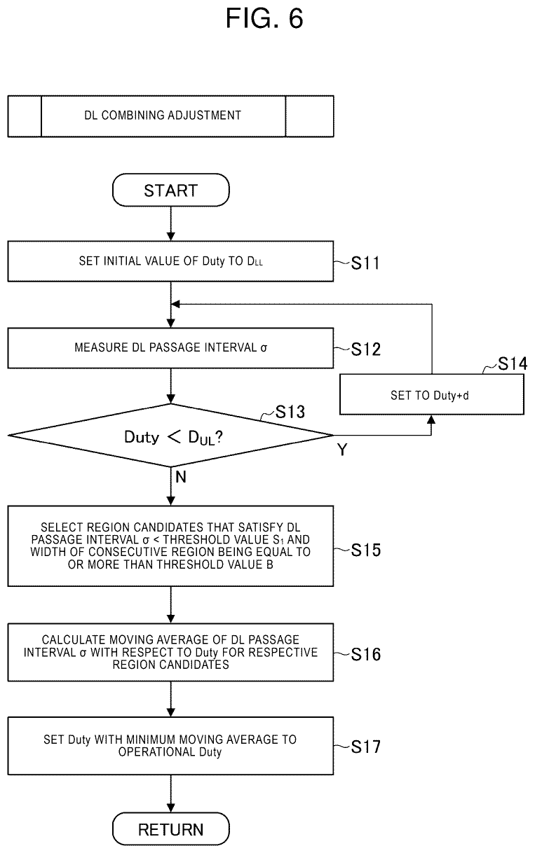

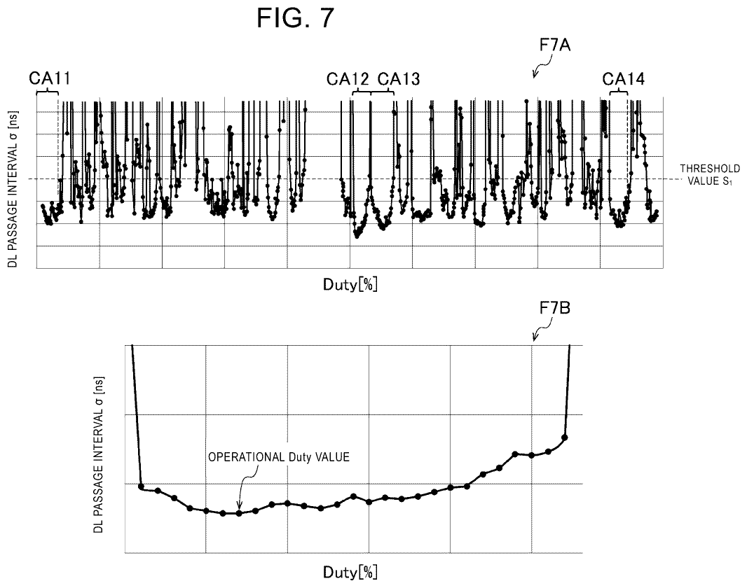

In step S3, the EUV light generation processor 24 performs processing of DL combining adjustment. The DL combining adjustment is the processing of adjusting into an appropriate Duty using the DL passage interval σ as an index. A specific example of a subroutine of the DL combining adjustment applied to step S3 will be described later with reference to FIGS. 6 and 7.

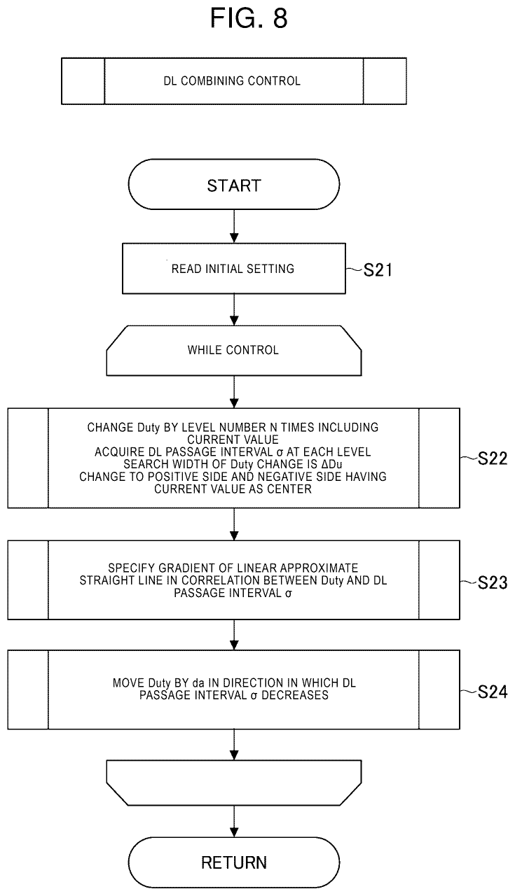

Thereafter, in step S4, the EUV light generation processor 24 starts the DL combining control to maintain a DL combining state by finely adjusting the Duty. Here, the DL combining control may be performed irrespective of non-irradiation (at the time of EUV non-emission) and irradiation (at the time of EUV emission) to the DL 82 with the pulse laser light. A specific example of a subroutine applied to the DL combining control in step S4 will be described later with reference to FIG. 8.

After step S4 is completed, the EUV light generation processor 24 ends the flowchart of FIG. 5.

2.2.1 Example of DL combining adjustment

FIG. 6 is a flowchart showing an example of the subroutine of the DL combining adjustment applied to step S3 in FIG. 5. The present subroutine is executed during DL discharging at the time of EUV non-emission.

When the process in step S3 is started, in step S11, the EUV light generation processor 24 reads initial parameters and sets the Duty of the piezoelectric element 47 to a lower limit value D_{LL} which is an initial value. In addition to the lower limit value D_{LL}, the initial parameters include an upper limit value D_{UL}, a step amount d, a number of calculation samples of the DL passage interval σ, a moving average number No of the DL passage interval σ, a threshold value S₁ of the DL passage interval σ, and a threshold value B of consecutive Duty width determination.

As typical values of the initial parameters, the lower limit value D_{LL} may be 1%, the upper limit value D_{UL} may be 99%, the step amount d may be 0.18, the number of calculation samples of the DL passage interval σ may be 10000, the moving average number No of the DL passage interval σ may be 0.6%, and the threshold value S₁ of the DL passage interval σ may be 170 ns. When the step amount d is 0.18, the moving average number No of the DL passage interval σ being 0.6% means that the number of sections of the moving average is 0.6÷0.1=6. Further, the threshold value B of the consecutive Duty width determination may be set by determining a value, by experiment or the like, with which DL combining performance can be maintained for a long period of time. The threshold value B of the consecutive Duty width determination may be 0.6% or more and, for example, the threshold value B may be 0.6%.

The EUV light generation processor 24 can change the Duty in units of the step amount d in a numerical range from the lower limit value D_{LL} to the upper limit value D_{UL}.

In step S12, the EUV light generation processor 24 measures the DL passage interval σ with each Duty value. That is, the EUV light generation processor 24 controls the piezoelectric power source 37 so as to apply the voltage waveform of the rectangular wave having the set Duty to the piezoelectric element 47, and drives the piezoelectric element 47 via the piezoelectric power source 37 to generate the DL 82. Further, the EUV light generation processor 24 acquires the passage timing signal TS, and calculates the DL passage interval σ based on the passage timing signal TS and Expression 1. The number of DLs for each Duty value, which is the number of calculation samples of the DL passage interval σ, may be 10000. Then, the EUV light generation processor 24 stores the Duty and the DL passage interval σ in association with each other in a memory.

In step S13, the EUV light generation processor 24 determines whether or not the set Duty value is smaller than the upper limit value D_{UL}. When the determination result in step S13 is Yes, the EUV light generation processor 24 proceeds to step S14, sets a new Duty value by adding the step amount d to the set Duty value, and then returns to step S12.

The loop of steps S12 to S14 is repeated until the Duty value reaches the upper limit value D_{UL}. Thus, by measuring the DL passage interval σ with each Duty value while increasing the Duty from the lower limit value D_{LL} to the upper limit value D_{UL} in increments of the step amount d, characteristic data (see FIG. 7) indicating the relationship between the Duty and the DL passage interval σ can be obtained.

When the Duty value reaches the upper limit value D_{UL} and the determination result in step S13 is No, the EUV light generation processor 24 proceeds to step S15. In step S15, the EUV light generation processor 24 selects region candidates that satisfy the condition that the DL passage interval σ is less than the threshold value S₁ and that the width of the region (consecutive region) of the consecutive Duty is equal to or more than the threshold value B.

In step S16, the EUV light generation processor 24 calculates the moving averages of the DL passage interval σ with respect to the Duty for the respective region candidates selected in step S15. In place of the moving average, the EUV light generation processor 24 may perform a filter operation on the data sequence to smooth out protruding data.

In step S17, the EUV light generation processor 24 sets the Duty value with which the moving average calculated in step S16 is the minimum to the operational Duty value. After step S17, the EUV light generation processor 24 returns to the flowchart of FIG. 5.

FIG. 7 is a graph showing an example of the DL passage interval σ measured in the DL combining adjustment. In FIG. 7, the horizontal axis represents the Duty, and the vertical axis represents the DL passage interval σ. F7A at the upper stage of FIG. 7 shows an example of the DL passage interval σ obtained by scanning with the Duty value being from 1% to 99% in increments of 0.1% while the irradiation of the pulse laser light is stopped.

In F7A at the upper stage, for example, four region candidates CA11, CA12, CA13, CA14 are regions satisfying the condition that the DL passage interval σ is less than the threshold value S₁ and the width of the consecutive region is equal to or more than the threshold value B of the consecutive Duty width determination. The region candidates CA11, CA12, CA13, CA14 are regions in the vicinity of the Duty values of 3%, 53%, 56%, and 93%, respectively.

Here, the moving average of the DL passage interval σ with the Duty is calculated for each of the four region candidates CA11, CA12, CA13, CA14, and the operational Duty value is set to the Duty value with which the moving average is the minimum. F7B at the lower stage of FIG. 7 shows an enlarged graph of the region candidate CA12, and shows an example of the operational Duty value set from the moving averages.

### 2.2.2 Example of DL Combining Control

FIG. 8 is a flowchart showing an example of a subroutine of DL combining control applied to step S4 in FIG. 5. In the subroutine of the DL combining control of FIG. 8, the Duty is controlled using the DL passage interval σ as an index. The present subroutine can be performed at both the time of EUV non-light emission and the time of EUV light emission.

When the process of step S4 is started, in step S21, the EUV light generation processor 24 reads initial settings. The parameters for performing the initial setting include a search range ΔDu of the Duty value, a search level number N of the Duty, a Duty moving amount da, and a number of calculation samples Ns of the DL passage interval σ. The EUV light generation processor 24 reads the initial set value for each of these parameters. For example, as the typical values of the parameters, the search width ΔDu may be 0.02%, the search level number N may preferably be 2 or more, for example, 5, the Duty moving amount da may be 0.02%, and the number of calculation samples of the DL passage interval σ may be 10000.

In step S22, the EUV light generation processor 24 changes the Duty by the search level number N times including the current value, based on the initial settings read in step S21, and acquires the DL passage interval σ at each level. The interval between the search level numbers N may be the search width ΔDu, and the order of the Duty value to be set at the time of the level change may be arbitrary. In addition, it is desirable that the range to be searched for by the search width ΔDu is set to a range in which a significant difference in DL combining performance is obtained.

The EUV light generation processor 24 changes the Duty to the positive side and the negative side having the current value of the Duty as the center, and drives the piezoelectric element 47 at the respective Duty values at the N levels to generate the DL 82. The EUV light generation processor 24 acquires the DL passage interval σ for the generated DL 82 and obtains a correlation between the Duty and the DL passage interval σ.

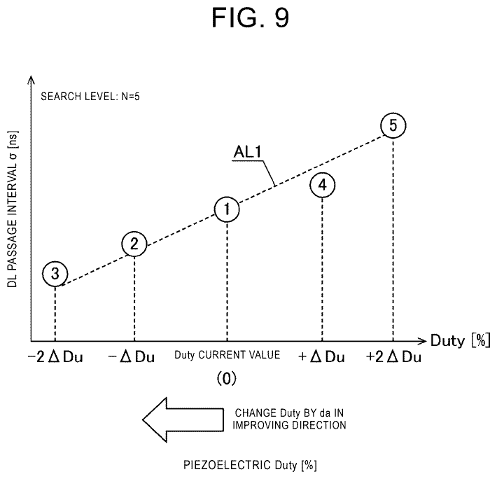

In step S23, the EUV light generation processor 24 calculates a linear approximate straight line with the Duty as the horizontal axis and the DL passage interval σ as the vertical axis in the correlation between the Duty and the DL passage interval σ acquired in step S22, and specifies the gradient thereof (see FIG. 9).

In step S24, the EUV light generation processor 24 changes the Duty in the performance improving direction, that is, in the direction in which the DL passage interval σ decreases, based on the gradient of the approximate straight line specified in step S23. For example, when the gradient is positive, the EUV light generation processor 24 changes the Duty from the current value (0 position) to the negative direction. Further, when the gradient is negative, the EUV light generation processor 24 changes the Duty from the current value to the positive direction. The change amount of the Duty at this time may be set to a Duty value that differs from the current value by the moving amount d, or any Duty value that is in the performance improving direction. The change amount in the Duty may be different depending on the value of the gradient. Thereafter, the piezoelectric element 47 is driven with the Duty value having the smaller DL passage interval σ.

Here, when the absolute value of the gradient can be regarded as 0, the EUV light generation processor 24 may not change the Duty.

After step S24, the EUV light generation processor 24 returns to step S22 and repeats the same processes (steps S22 to S24) using the changed Duty as the current value.

The processes of steps S22 to S24 are for maintaining the DL combining state by finely adjusting the Duty value using the DL passage interval σ as an index, and are performed repeatedly as long as the combining state of the DL needs to be maintained. When there is no need to maintain the DL combining state in association with the stop of DL outputting by a stop command or the like from an operator or an external apparatus (not shown), the EUV light generation processor 24 ends the repetitive processes and ends the present subroutine.

FIG. 9 is a graph for explaining the process of changing the Duty in the performance improving direction. In FIG. 9, the horizontal axis represents the Duty, and the vertical axis represents the DL passage interval σ. Each circle in FIG. 9 represents a plot position of the DL passage interval σ with respect to the Duty, and a number in the circle represents a search order. In the example shown in FIG. 9, the Duty values of the search orders 1, 2, 3, 4, and 5 are “current value”, “current value-ΔDu”, “current value-ΔDu×2”, “current value+ΔDu”, and “current value+ΔDu×2”, respectively. From these five plot points, an approximate straight line AL1 indicated by a broken line in FIG. 9 can be obtained by linear approximation.

In the example of FIG. 9, a gradient of the approximate straight line AL1 has a positive value, and the direction in which the Duty is decreased with respect to the current value is the direction in which the value of the DL passage distance o is improved. Therefore, in this case, as the process of step S24, the Duty value is changed from the current value to the negative direction by the moving amount da.

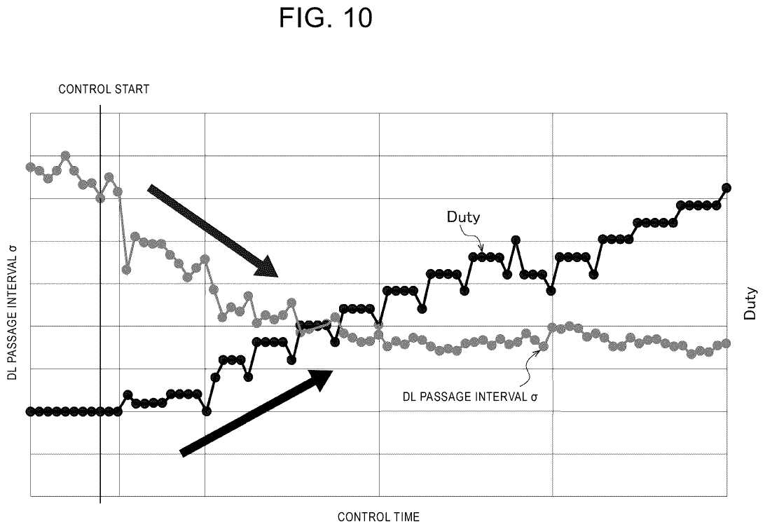

FIG. 10 is a graph showing an example of change in the DL passage interval σ and the Duty with respect to the control time in the DL combining control. In this example, the DL passage interval σ is improved by being controlled so as to increase the Duty value in a broad sense.

### 2.3 Problem

In the DL combining control (FIG. 8) according to the comparative example, optimization condition search for searching for piezoelectric Duty at N levels is performed as having the piezoelectric Duty of an initial level (current value) as the center. Therefore, when a piezoelectric Duty causing deterioration of the DL passage interval σ exists in the vicinity of the piezoelectric Duty causing a favorable DL passage interval σ, there is a possibility that the piezoelectric Duty causing deterioration of the DL passage interval σ is set in the process of the optimization condition search.

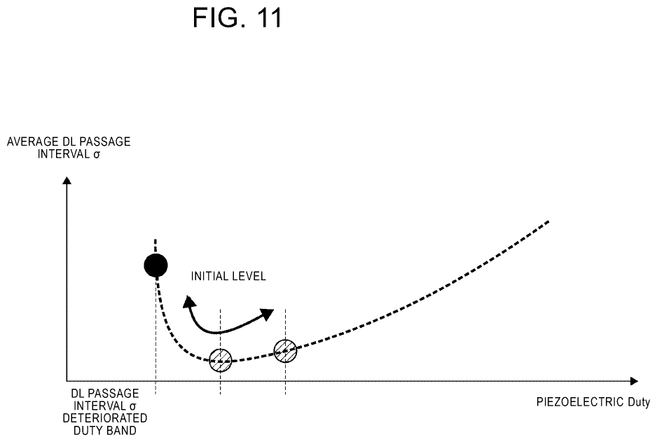

FIG. 11 is an explanatory diagram showing a problem of operation of setting the piezoelectric Duty causing deterioration of the DL passage interval σ in the search process of the DL combining control.

FIG. 11 shows an example of a graph of an average DL passage interval σ at Duty values of three levels including the piezoelectric Duty at an initial level. In FIG. 11, on the negative side of the piezoelectric Duty at the initial level, there is a Duty band in which the DL passage interval σ is deteriorated in the vicinity of the piezoelectric Duty at the initial level, and when the Duty is set to a Duty value level at a level on the negative side from the piezoelectric Duty at the initial level, the DL passage interval σ is greatly deteriorated.

As a result, relative position deviation occurs between the laser light and the DL 82, which leads to deterioration in EUV energy stability. Further, since the DL detection cycle of the passage timing signal TS varies and the laser irradiation period varies, the EUV emission period also varies.

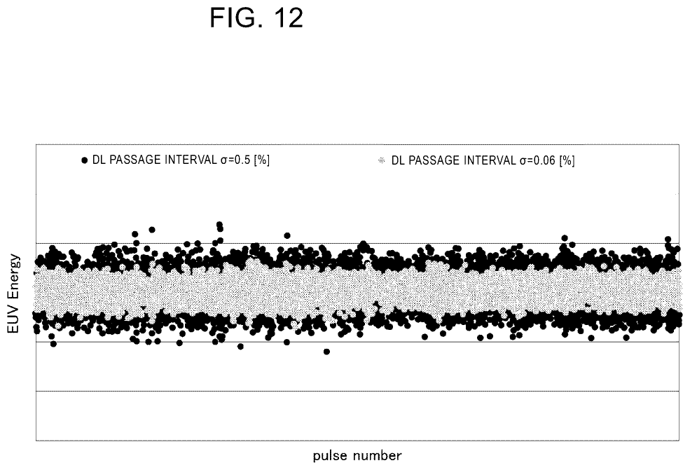

FIG. 12 is a graph comparing EUV energies in a case in which the DL passage interval σ is favorable and a case in which the DL passage interval σ is deteriorated. In FIG. 12, the horizontal axis represents the pulse number, and the vertical axis represents the EUV energy. In FIG. 12, an example of a case in which the DL passage interval σ is 0.06 [%] is shown as an example of a case in which the DL passage interval σ is favorable, and an example of a case in which the DL passage interval σ is 0.5 [%] is shown as an example of a case in which the DL passage interval σ is deteriorated. In each case, the EUV energy measured for each pulse of 20000 pulses is plotted.

As shown in FIG. 12, when the DL passage interval σ is deteriorated, the EUV energy stability is deteriorated.

Therefore, there has been a demand for the EUV light generation apparatus 10 capable of avoiding the piezoelectric Duty causing deterioration of the DL passage interval σ.

### 3. First Embodiment

### 3.1 Configuration

The configuration of the EUV light generation apparatus 10 according to a first embodiment is similar to that of the EUV light generation apparatus 10 shown in FIG. 4.

### 3.2 Operation

The operation of the EUV light generation apparatus 10 according to the first embodiment will be described in terms of differences from the operation of the EUV light generation apparatus 10 according to the comparative example. The operation of the EUV light generation apparatus 10 according to the first embodiment is different from the operation of the EUV light generation apparatus 10 according to the comparative example in the DL combining adjustment subroutine and the DL combining control subroutine.

3.2.1 Example of DL combining adjustment

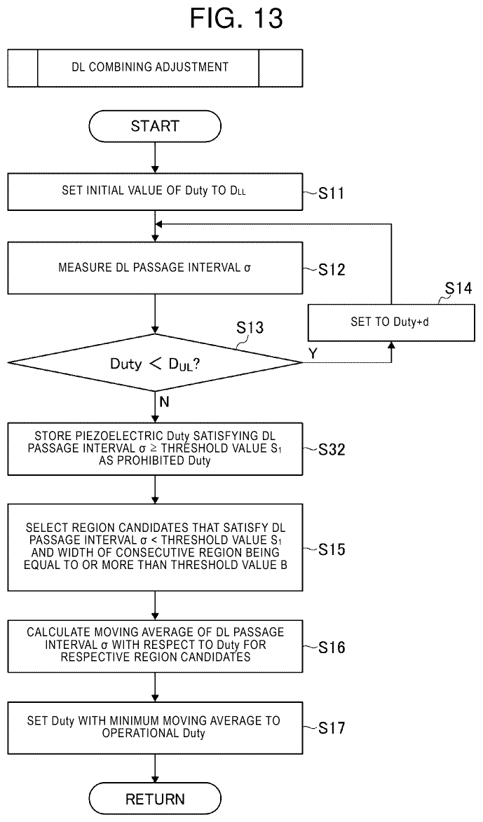

FIG. 13 is a flowchart showing an example of the DL combining adjustment subroutine applied to the EUV light generation apparatus 10 according to the first embodiment. In the EUV light generation apparatus 10 according to the first embodiment, the flowchart of FIG. 13 is applied in step S3 in FIG. 5. FIG. 13 will be described in terms of differences from FIG. 6.

The flowchart shown in FIG. 13 includes step S32 between step S13 and step S15. That is, when the determination result in step S13 is No, the EUV light generation processor 24 proceeds to step S32.

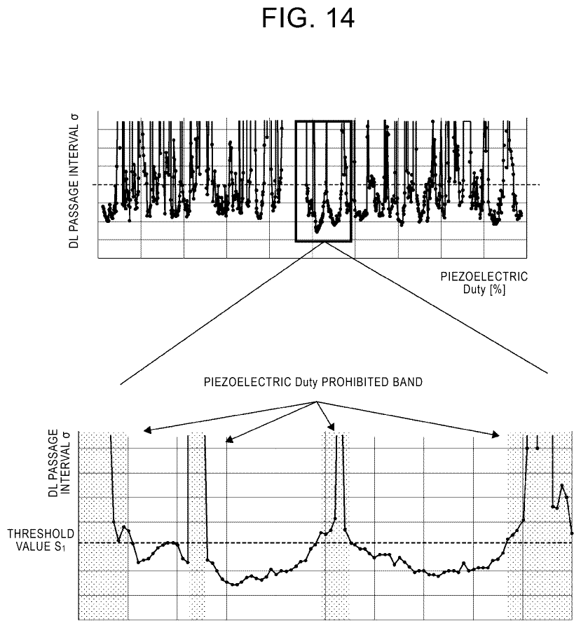

In step S32, the EUV light generation processor 24 stores the piezoelectric Duty with which the DL passage interval σ is equal to or more than the threshold value S₁ as the prohibited Duty based on the data of the DL passage interval σ acquired in step S12 (see FIG. 14). After step S32, the EUV light generation processor 24 proceeds to step S15. Other steps are similar to those in FIG. 6. The threshold value S₁ is an example of the “first threshold value” in the present disclosure. The prohibited Duty is an example of the “prohibited duty” in the present disclosure.

The DL passage interval σ with each Duty changes over time. Therefore, the piezoelectric Duty stored in step S32 may be deleted after a predetermined period of time (for example, 30 minutes) elapses or every time the DL combining adjustment for reacquiring the DL passage interval σ with each Duty is performed.

FIG. 14 is an explanatory diagram showing an example of the prohibited Duty stored in step S32 based on the measurement result of the DL passage interval σ in step S12.

The upper stage of FIG. 14 shows a graph showing an example of the measurement result of the DL passage interval o. The lower stage of FIG. 14 shows a graph in which a part of the graph shown in the upper stage (a part surrounded by a bold rectangular frame) is enlarged, and regions of the piezoelectric Duty each having the DL passage interval σ equal to or more than the threshold value S₁ are indicated by a fill pattern.

In the lower stage of FIG. 14, regions of the Duty indicated by the fill pattern are prohibited bands of the piezoelectric Duty, and the Duty belonging to any prohibited band is stored as the prohibited Duty that cannot be set.

### 3.2.2 Example of DL Combining Control

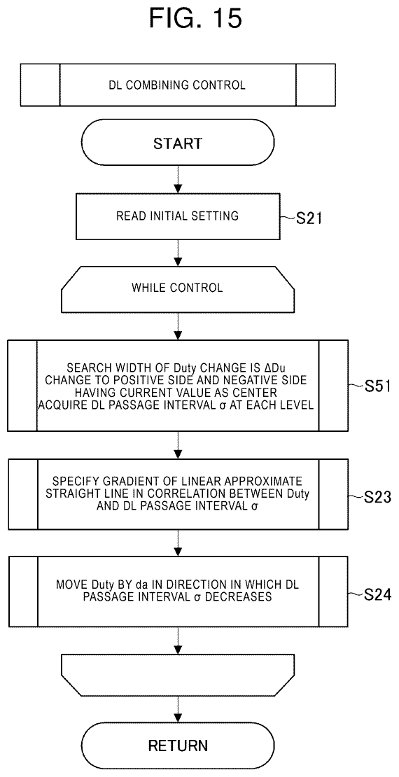

FIG. 15 is a flowchart showing an example of the DL combining control subroutine applied to the EUV light generation apparatus 10 according to the first embodiment. In the EUV light generation apparatus 10 according to the first embodiment, the flowchart of FIG. 15 is applied in step S4 in FIG. 5. FIG. 15 will be described in terms of differences from FIG. 8.

In step S21 in FIG. 15, in addition to the parameters described in step S21 in FIG. 8, the EUV light generation processor 24 reads the information stored in the DL combining adjustment (FIG. 14) on the piezoelectric Duty with which the DL passage interval σ is equal to or more than the threshold value S₁, that is, the information on the prohibited Duty.

Further, the flowchart shown in FIG. 15 includes step S51 in place of step S22 in FIG. 8.

In step S51 after step S21, the EUV light generation processor 24 changes the Duty by the search width ΔDu to each of the positive side and the negative side having the current value of the Duty as the center, and acquires the DL passage interval σ at each level (see FIG. 9). However, in step S51, when the Duty after the change by the search width ΔDu corresponds to the prohibited Duty or crosses the prohibited Duty, the EUV light generation processor 24 does not set the piezoelectric Duty to the positive side (or the negative side) from the Duty value of the level before the change.

Further, in step S24, when the Duty after the change by da corresponds to the prohibited Duty or crosses the prohibited Duty, the piezoelectric Duty is not to be set. Other operation may be similar to those in the flowchart of FIG. 8. The approximate straight line AL1 (FIG. 9) in step S23 in FIG. 15 is an example of the “approximate straight line” in the present disclosure.

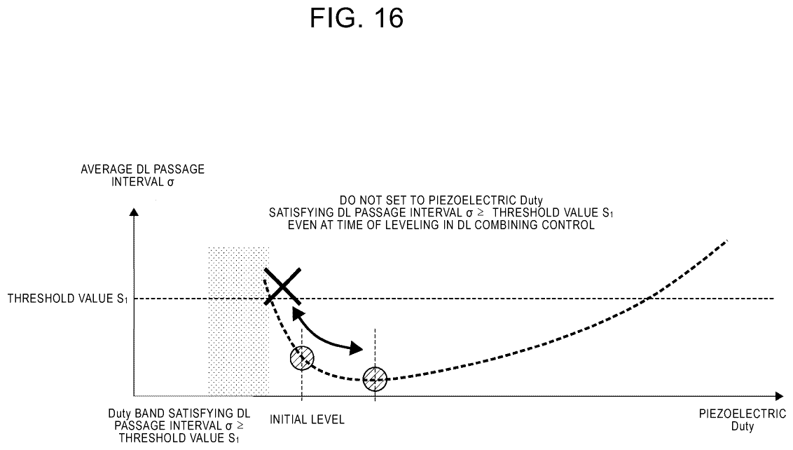

FIG. 16 is a conceptual diagram of operation in which setting to a prohibited Duty or a piezoelectric Duty that crosses a prohibited Duty is prohibited. In FIG. 16, the horizontal axis represents the piezoelectric Duty, and the vertical axis represents the average DL passage interval σ. In the operation of the DL combining control, the DL passage interval σ is measured when the piezoelectric Duty is changed, for example, by changing the piezoelectric Duty in units of the search width ΔDu from the initial level. However, as shown in FIG. 16, even in the case of the piezoelectric Duty search in which the piezoelectric Duty is changed in the DL combining control to acquire the DL passage interval σ, the piezoelectric Duty with which the DL passage interval σ is equal to or more than the threshold value S₁ is not set by the EUV light generation processor 24. That is, the EUV light generation processor 24 sets the piezoelectric Duty while avoiding the prohibited Duty in the operation of the piezoelectric Duty search in the DL combining control, and performs the optimization condition search. Further, the EUV light generation processor 24 sets the piezoelectric Duty while avoiding the prohibited Duty even in the setting of the piezoelectric Duty in the performance improving direction based on the result of the piezoelectric Duty search.

The droplet generation control method to be performed by the EUV light generation processor 24 in the first embodiment is an example of the “droplet generation control method” in the present disclosure.

### 3.3 Effect

According to the EUV light generation apparatus 10 of the first embodiment, setting to the piezoelectric Duty with which the DL passage interval σ is equal to or more than the threshold value S₁ is prevented in the operation of the DL combining control. Therefore, the EUV energy stability is improved compared to that of the EUV light generation apparatus 10 according to the comparative example.

### 3.4 Modification

### 3.4.1 Configuration

The configuration of the EUV light generation apparatus 10 according to a modification of the first embodiment may be similar to that of the EUV light generation apparatus 10 shown in FIG. 4.

### 3.4.2 Operation

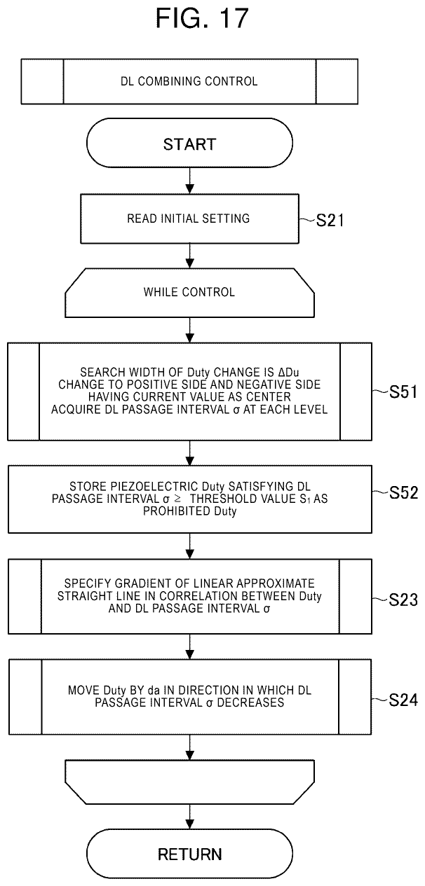

FIG. 17 is a flowchart showing an example of the DL combining control subroutine applied to the EUV light generation apparatus 10 according to the modification of the first embodiment. In place of the flowchart of FIG. 15, the flowchart of FIG. 17 may be applied. FIG. 17 will be described in terms of differences from FIG. 15.

In step S21 in FIG. 17, in addition to the parameters and information on the prohibited Duty described in step S21 in FIG. 15, the EUV light generation processor 24 reads the threshold value S₁ of the DL passage interval σ.

Further, the flowchart shown in FIG. 17 includes step S52 between step S51 and step S23.

In step S52, when the piezoelectric Duty with which the DL passage interval σ is equal to or more than the threshold value S₁ exists during the operation of the piezoelectric Duty search in step S51, the EUV light generation processor 24 stores the piezoelectric Duty as the prohibited Duty. That is, the EUV light generation processor 24 acquires the DL passage interval σ again for each Duty set during the Duty combining control (during the operation in step S51), and when a piezoelectric Duty with which the DL passage interval σ is equal to or more than the threshold value S₁ is newly found, the EUV light generation processor 24 updates the information on the prohibited DL as adding the piezoelectric Duty as the prohibited Duty so that the piezoelectric Duty is prohibited to be set.

Other operation may be similar to those in the flowchart of FIG. 15. Here, similarly to the piezoelectric Duty stored in step S32, the piezoelectric Duty stored in step S52 may also be deleted after a predetermined period of time elapses or every time the DL combining adjustment for reacquiring the DL passage interval σ with each Duty is performed.

### 3.4.3 Effect

As described above, the relationship between the Duty and the DL passage interval σ may change over time. Therefore, the DL passage interval σ may deteriorate over time even with the Duty in the region candidate with which the DL passage interval σ has been favorable at the time of the DL combining adjustment.

Therefore, by adding the piezoelectric Duty with which the DL passage interval σ has been equal to or more than the threshold value S₁ even in the operation of the DL combining control as the prohibited Duty (step S52), the piezoelectric Duty with which deterioration of the DL passage interval σ occurs is prevented from being set in the operation of the subsequent DL combining control. Accordingly, the EUV energy stability can be further improved.

### 4. Second Embodiment

### 4.1 Configuration

The configuration of the EUV light generation apparatus 10 according to a second embodiment is similar to that of the EUV light generation apparatus 10 shown in FIG. 4.

### 4.2 Operation

The operation of the EUV light generation apparatus 10 according to the second embodiment will be described in terms of differences from the operation of the EUV light generation apparatus 10 according to the first embodiment. In the first embodiment, description has been provided on an example in which the DL combining state is evaluated using the DL passage interval σ as an index, but in the second embodiment, description will be provided on an example in which the combining failure rate of the DL 82 is used as the droplet parameter in place of the DL passage interval σ.

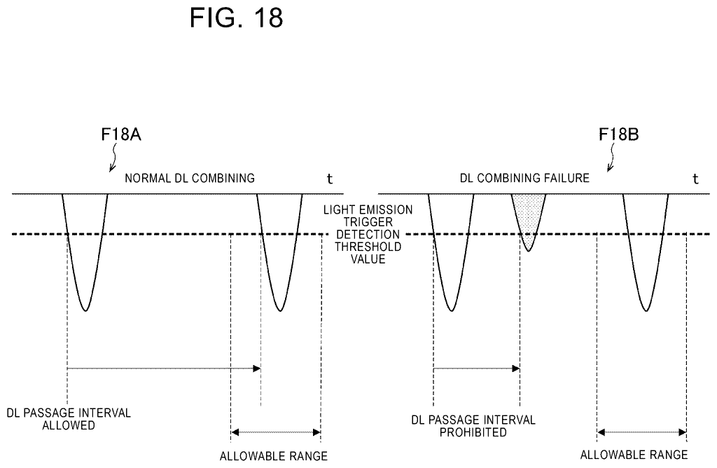

FIG. 18 is an explanatory diagram of the combining failure rate. As in FIG. 2, FIG. 18 shows a schematic diagram of a passage timing signal. F18A on the left side shows an example of the signal when the DL combining is normal, and F18B on the right side shows an example of the signal when the DL combining is defective.

To evaluate the DL combining performance, the EUV light generation processor 24 sets an allowable range of the DL passage interval, determines whether the detection interval (DL passage interval) from when a signal that falls below the light emission trigger detection threshold value is detected until when the subsequent signal falls below the light emission trigger detection threshold value is within the allowable range, and calculates the combining failure rate according to Expression 2 below. The allowable range is, for example, ±1000 ns.

Combining failure rate [%]=(number of DL with which DL passage interval is out of the allowable range)/(number of DL samples)×100 Expression 2

The number of samples in Expression 2 may be, for example, 10000 pulses. The number of DL samples and the allowable range of the DL passage interval can be appropriately set in accordance with practical requirements.

The “number of DL samples” can be replaced with the “number of times of DL passage interval measurement”, and the “number of DL with which DL passage interval is out of the allowable range” can be replaced with the “number of times of DL passage intervals outside the allowable range”. That is, the combining failure rate of Expression 2 is calculated by counting the number of DLs 82 with which the DL passage interval is out of the allowable range. Here, counting the DLs 82 is substantially equivalent to counting the number of times of the DL passage interval measurement. The combining failure rate is understood as a droplet parameter indicating a ratio of the number of DL passage intervals out of the allowable range with respect to the number of the DL passage interval measurement. The DL passage interval is an example of the “passage interval” in the present disclosure, and the number of DL passage intervals is an example of the “number of passage intervals” in the present disclosure.

In F18A on the left side of FIG. 18, the DL passage interval is within the allowable range, and diagram F18B on the right side, the DL passage interval is out of the allowable range.

The operation of the EUV light generation apparatus 10 according to the second embodiment is different from the operation of the EUV light generation apparatus 10 according to the first embodiment in the DL combining adjustment subroutine and the DL combining control subroutine.

### 4.2.1 Example of DL Combining Adjustment

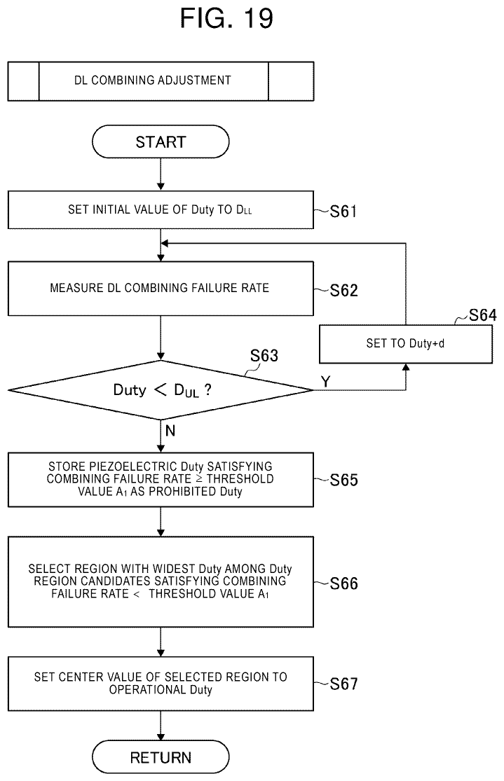

FIG. 19 is a flowchart showing an example of the DL combining adjustment subroutine applied to the EUV light generation apparatus 10 according to the second embodiment. In the EUV light generation apparatus 10 according to the second embodiment, the flowchart of FIG. 19 is applied in place of the flowchart of FIG. 13. FIG. 19 will be described in terms of differences from FIG. 13.

Step S61 in FIG. 19 is similar to step S11 in FIG. 13. However, in step S61, among the initial parameters read in step S11, the number of calculation samples for the combining failure rate and a threshold value A₁ of the combining failure rate are read in place of the number of calculation samples for the DL passage interval σ and the threshold value S₁ of the DL passage interval σ. The number of calculation samples for the combining failure rate is the “number of DL samples” in Expression 2. As typical values of the initial parameters, the number of calculation samples for the combining failure rate may be 10000, and the threshold value A₁ of the combining failure rate may be 0.02 [%]. Other initial parameters are similar to those in step S11. The threshold value A₁ is an example of the “second threshold value” in the present disclosure.

In step S62, the EUV light generation processor 24 measures the combining failure rate. That is, the EUV light generation processor 24 controls the piezoelectric power source 37 so as to apply the voltage waveform of the rectangular wave having the set Duty to the piezoelectric element 47, and drives the piezoelectric element 47 via the piezoelectric power source 37 to generate the DL 82. Further, the EUV light generation processor 24 acquires the passage timing signal TS, and calculates the combining failure rate based on the passage timing signal TS and Expression 2. Then, the EUV light generation processor 24 stores the Duty and the combining failure rate in association with each other.

Step S63 and step S64 are similar to step S13 and step S14 in FIG. 13. When the determination result in step S63 is Yes, the EUV light generation processor 24 returns to step S62 after step S64.

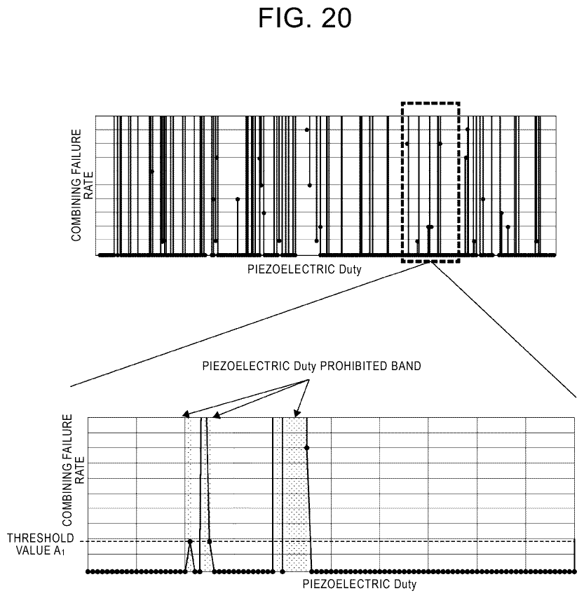

The loop of steps S62 to S64 is repeated until the Duty value reaches an upper limit value D_{UL}, and the combining failure rate is measured with each Duty value from a lower limit value D_{LL} to the upper limit value D_{UL}. Accordingly, characteristic data (see FIG. 20) indicating the relationship between the Duty and the combining failure rate is obtained.

When the determination result in step S63 is No, the EUV light generation processor 24 proceeds to step S65. In step S65, the EUV light generation processor 24 stores, as the prohibited Duty, the piezoelectric Duty with which the combining failure rate is equal to or more than the threshold value A₁.

In S66, the EUV light generation processor 24 sets, as the Duty region candidates, regions each having a contiguous Duty satisfying the condition that the combining failure rate is less than the threshold value A₁ and selects the widest region among the Duty candidate regions.

In step S67, the EUV light generation processor 24 sets the center value of the region selected in step S66 to an operational Duty.

After step S67, the EUV light generation processor 24 returns to the flowchart of FIG. 5.

Here, since the DL passage interval σ with each Duty varies over time, the piezoelectric Duty stored in step S65 may be deleted after a predetermined period of time (for example, 30 minutes) elapses or every time the DL combining adjustment for reacquiring the combining failure rate with each Duty is performed.

FIG. 20 is an explanatory diagram showing an example of the prohibited Duty stored in step S65 based on the measurement result of the combining failure rate in step S62.

The upper stage of FIG. 20 shows a graph showing an example of the measurement result of the combining failure rate. The lower stage of FIG. 20 shows a graph in which a part of the graph shown in the upper part (a part surrounded by a rectangular broken-line frame) is enlarged, and regions of the piezoelectric Duty each having the combining failure rate equal to or more than the threshold value A₁ are indicated by a fill pattern.

In the lower stage of FIG. 20, regions of the Duty indicated by the fill pattern are prohibited bands of the piezoelectric Duty, and the Duty belonging to any prohibited band is stored as the prohibited Duty that cannot be set.

### 4.2.2 Example of DL Combining Control

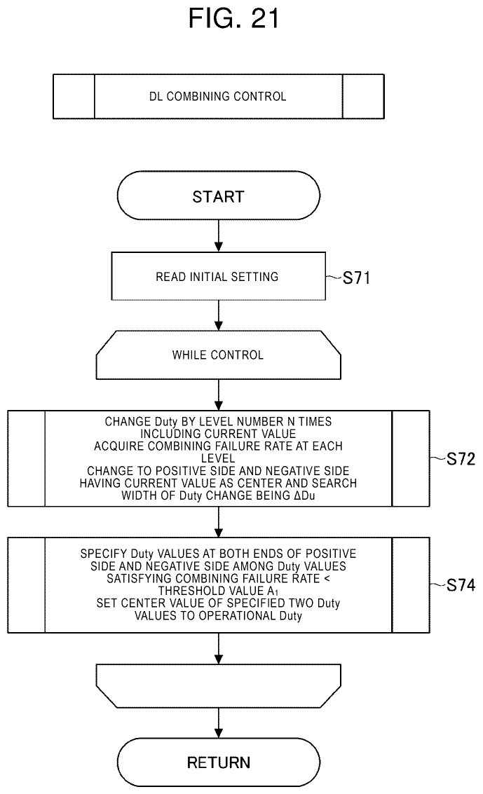

FIG. 21 is a flowchart showing an example of the DL combining control subroutine applied to the EUV light generation apparatus 10 according to the second embodiment. In the EUV light generation apparatus 10 according to the second embodiment, the flowchart of FIG. 21 is applied in place of the flowchart of FIG. 15. FIG. 21 will be described in terms of differences from FIG. 15.

Step S71 in FIG. 21 is similar to step S21 in FIG. 15. However, in step S71, among the initial parameters read in step S21, the number of calculation samples for the combining failure rate and the threshold value A of the combining failure rate are read in place of the number of calculation samples for the DL passage interval σ and the threshold value S₁ of the DL passage interval σ. Further, in step S71, in place of the information of the piezoelectric Duty with which the DL passage interval σ is equal to or more the threshold value S₁ described in step S21 in FIG. 15, the EUV light generation processor 24 reads the information on the piezoelectric Duty, stored in the DL combining adjustment (FIG. 19), with which the combining failure rate is equal to or more than the threshold value A₁.

In step S72, the EUV light generation processor 24 changes the Duty by the search level number N times including the current value, based on the initial settings read in step S71, and acquires the combining failure rate at each level. As in step S51, the search width of the search level number N is ΔDu, and the EUV light generation processor 24 changes the Duty to the positive side and the negative side having the current value of the Duty as the center, and drives the piezoelectric element 47 at the respective Duty values of the N levels to generate the DL 82, thereby acquiring the combining failure rate at the respective levels. However, in step S72 as well, when the Duty after the change by the search width ΔDu corresponds to the prohibited Duty or crosses the prohibited Duty, the EUV light generation processor 24 does not set the piezoelectric Duty to the positive side (or the negative side) from the Duty value of the level before the change. Due to step S72, data indicating the relationship between the Duty and the combining failure rate is obtained.

In step S74, the EUV light generation processor 24 specifies the Duty values at both ends of the positive side and the negative side among Duty values with which the combining failure rate is less than the threshold value A₁ from the data obtained in step S72. Then, the EUV light generation processor 24 sets the center value of the two specified Duty values as the operational Duty.

Further, in step S74, when the Duty after the change to be set as the operational Duty corresponds to the prohibited Duty or crosses the prohibited Duty, the piezoelectric Duty is not to be set.

After step S74, the EUV light generation processor 24 returns to step S72 and repeats the same processes (steps S72 to S74) using the changed Duty as the current value.

The processes of steps S72 to S74 are for maintaining the DL combining state by finely adjusting the Duty value using the combining failure rate as an index, and are performed repeatedly as long as the combining state of the DL needs to be maintained. When there is no need to maintain the DL combining state in association with the stop of DL outputting by a stop command or the like from an operator or an external apparatus (not shown), the EUV light generation processor 24 ends the repetitive processes and ends the present subroutine.

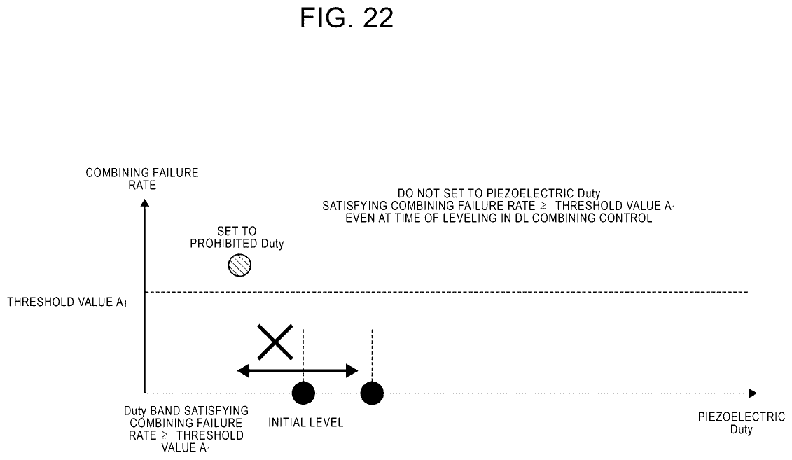

FIG. 22 is a conceptual diagram of operation in which setting to a prohibited Duty or a piezoelectric Duty that crosses the prohibited Duty is prohibited. In FIG. 22, the horizontal axis represents the piezoelectric Duty, and the vertical axis represents the combining failure rate. In the operation of the DL combining control, the combining failure rate is measured when the piezoelectric Duty is changed, for example, by changing the piezoelectric Duty in units of the search width ΔDu from the initial level. However, as shown in FIG. 22, even in the case of the piezoelectric Duty search in the DL combining control, the piezoelectric Duty with which the combining failure rate is equal to or more than the threshold value A₁ is not set by the EUV light generation processor 24. That is, the EUV light generation processor 24 sets the piezoelectric Duty while avoiding the prohibited Duty in the operation of the piezoelectric Duty search in the DL combining control, and performs the search. Further, the EUV light generation processor 24 sets the piezoelectric Duty while avoiding the prohibited Duty even in the setting of the piezoelectric Duty to the center of Duty values at both ends specified based on the result of the piezoelectric Duty search.

### 4.3 Effect

According to the EUV light generation apparatus 10 of the second embodiment, setting to the piezoelectric Duty with which the combining failure rate is equal to or more than the threshold value A₁ is prevented in the operation of the DL combining control. Therefore, the EUV energy stability is improved compared to that of the EUV light generation apparatus 10 according to the comparative example.

### 4.4 Modification

### 4.4.1 Configuration

The configuration of the EUV light generation apparatus 10 according to a modification of the second embodiment may be similar to that of the EUV light generation apparatus 10 shown in FIG. 4.

### 4.4.2 Operation

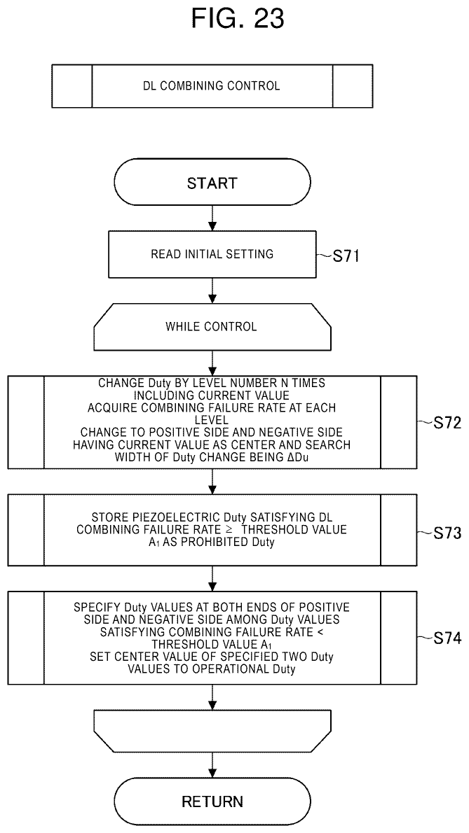

FIG. 23 is a flowchart showing an example of the DL combining control subroutine applied to the EUV light generation apparatus 10 according to the modification of the second embodiment. In place of the flowchart of FIG. 21, the flowchart of FIG. 23 may be applied. FIG. 23 will be described in terms of differences from FIG. 21.

The flowchart shown in FIG. 23 includes step S73 between step S72 and step S74.

In step S73, when the piezoelectric Duty with which the combining failure rate is equal to or more than the threshold value A₁ exists during the operation of the piezoelectric Duty search in step S72, the EUV light generation processor 24 stores the piezoelectric Duty as the prohibited Duty. That is, the EUV light generation processor 24 acquires the combining failure rate again for each Duty set during the Duty combining control (during the operation in step S72), and when a piezoelectric Duty with which the combining failure rate is equal to or more than the threshold value A₁ is newly found, the EUV light generation processor 24 updates the information on the prohibited DL as adding the piezoelectric Duty as the prohibited Duty so that the piezoelectric Duty is prohibited to be set.

Other operation may be similar to those in the flowchart of FIG. 21. Here, similarly to the piezoelectric Duty stored in step S65, the piezoelectric Duty stored in step S73 may also be deleted after a predetermined period of time elapses or every time the DL combining adjustment for reacquiring the combining failure rate with each Duty is performed.

### 4.4.3 Effect

The relationship between the Duty and combining failure rate may change over time. Therefore, the combining failure rate may deteriorate over time even with the Duty in the region candidate with which the combining failure rate has been favorable at the time of the DL combining adjustment.

Therefore, by additionally setting the piezoelectric Duty with which the combining failure rate has been equal to or more than the threshold value A₁ even in the operation of the DL combining control as the prohibited Duty (step S73), the piezoelectric Duty with which deterioration of the combining failure rate occurs is prevented from being set in the operation of the subsequent DL combining control. Accordingly, the EUV energy stability can be further improved.

### 5. Electronic Device Manufacturing Method

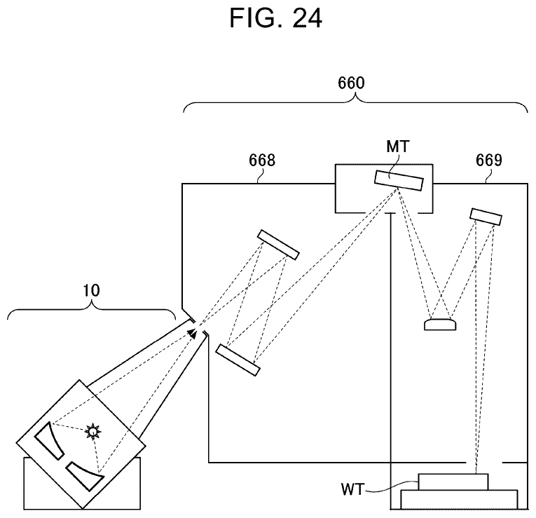

FIG. 24 is a diagram schematically showing the configuration of an exposure apparatus 660 connected to the EUV light generation apparatus 10. The exposure apparatus 660 includes a mask irradiation unit 668 and a workpiece irradiation unit 669. The mask irradiation unit 668 illuminates, via a reflection optical system, a mask pattern of the mask table MT with the EUV light incident from the EUV light generation apparatus 10. The workpiece irradiation unit 669 images the EUV light reflected by the mask table MT onto a workpiece (not shown) arranged on the workpiece table WT via a reflection optical system. The workpiece is a photosensitive substrate such as a semiconductor wafer on which photoresist is applied.

The exposure apparatus 660 synchronously translates the mask table MT and the workpiece table WT to expose the workpiece to the EUV light reflecting the mask pattern. Through the exposure process as described above, a device pattern is transferred onto the semiconductor wafer, thereby an electronic device can be manufactured.

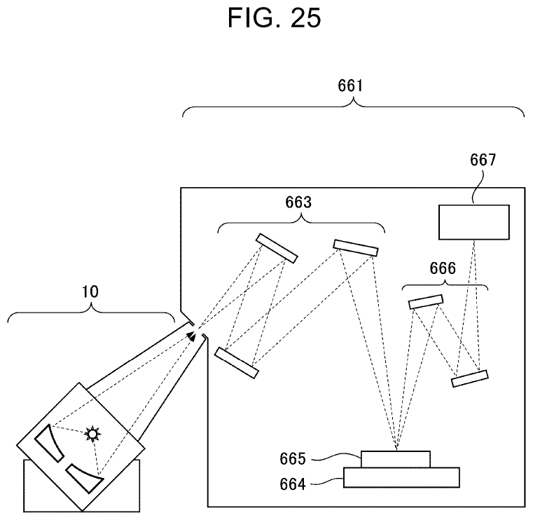

FIG. 25 is a diagram schematically showing the configuration of an inspection apparatus 661 connected to the EUV light generation apparatus 10. The inspection apparatus 661 includes an illumination optical system 663 and a detection optical system 666. The illumination optical system 663 reflects the EUV light incident from the EUV light generation apparatus 10 to illuminate a mask 665 placed on a mask stage 664. Here, the mask 665 conceptually includes a mask blanks before a pattern is formed. The detection optical system 666 reflects the EUV light from the illuminated mask 665 and forms an image on a light receiving surface of a detector 667. The detector 667 having received the EUV light obtains the image of the mask 665. The detector 667 is, for example, a time delay integration (TDI) camera.

Inspection for a defect of the mask 665 is performed based on the image of the mask 665 obtained by the above-described detection steps, and a mask suitable for manufacturing an electronic device is selected using the inspection result. Then, the electronic device can be manufactured by exposing and transferring the pattern formed on the selected mask onto the photosensitive substrate using the exposure apparatus 660.

### 6. Processor

The processor such as the EUV light generation processor 24 may be physically configured as hardware to execute various processes included in the present disclosure. For example, the processor may be a computer including a memory that stores a control program defining the various processes and a processing device that executes the control program. The control program may be stored in one memory, or may be stored separately in a plurality of memories at physically separate locations, and the various processes included may be defined by the control program as an aggregation thereof. The processing device may be a general-purpose processing device such as a central processing unit (CPU) or a special-purpose processing device such as graphics processing unit (GPU).

Alternatively, the processor may be programmed as software to execute the various processes included in the present disclosure. For example, the processor may be implemented in a dedicated device such as an application specific integrated circuit (ASIC) or a programmable device such as a field programmable gate array (FPGA).

The various processes included in the present disclosure may be executed by one computer, one dedicated device, or one programmable device, or may be executed by cooperation of a plurality of computers, a plurality of dedicated devices, or a plurality of programmable devices at physically separate locations. The various processes may be executed by a combination including at least any two of: one or more computers, one or more dedicated devices, and one or more programmable devices.

### 7. Others

The description above is intended to be illustrative and the present disclosure is not limited thereto. Therefore, it would be obvious to those skilled in the art that various modifications to the embodiments of the present disclosure would be possible without departing from the spirit and the scope of the appended claims. Further, it would be also obvious to those skilled in the art that the embodiments of the present disclosure would be appropriately combined.

The terms used throughout the present specification and the appended claims should be interpreted as non-limiting terms unless clearly described. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more”. Further, “at least one of A, B, and C” should be interpreted to mean any of A, B, C, A+B, A+C, B+C, and A+B+C as well as to include combinations of any thereof and any other than A, B, and C.

What is claimed is:

1. An extreme ultraviolet light generation apparatus configured to generate extreme ultraviolet light by irradiating droplets with laser light, comprising:
a tank configured to store a target substance in a liquid state;
a nozzle configured to output the target substance stored in the tank;
a piezoelectric element configured to apply vibration to the target substance to be output from the nozzle to generate the droplets of the target substance, the vibration reflecting an electric signal having a ratio of an on time in one cycle as a duty;
a timing sensor configured to measure a temporal passage interval of the droplets; and
a processor configured to:
output the electric signal to the piezoelectric element after setting the duty,
calculate a droplet parameter from the passage interval,
determine a prohibited duty that is the duty prohibited to be set based on data in which the duty and the droplet parameter with the duty are associated with each other, and
perform control of setting the duty of the electric signal based on the droplet parameter while avoiding the prohibited duty.

2. The extreme ultraviolet light generation apparatus according to claim 1,
wherein the droplet parameter is a variation of the passage interval.

3. The extreme ultraviolet light generation apparatus according to claim 2,
wherein the processor stores, as the prohibited duty, the duty with which the droplet parameter is equal to or more than a first threshold value.

4. The extreme ultraviolet light generation apparatus according to claim 2,
wherein the processor calculates an approximate straight line in a correlation between the duty set while avoiding the prohibited duty and the droplet parameter, and changes the duty in a direction in which the droplet parameter decreases based on a gradient of the approximate straight line.

5. The extreme ultraviolet light generation apparatus according to claim 1,
wherein the droplet parameter is calculated by counting the droplets whose passage interval is out of an allowable range.

6. The extreme ultraviolet light generation apparatus according to claim 1,
wherein the droplet parameter is calculated from a number of times of measurement of the passage interval and a number of times of the passage interval out of an allowable range.

7. The extreme ultraviolet light generation apparatus according to claim 6,
wherein the droplet parameter is a combining failure rate of the droplets indicating a ratio of the number of times of the passage interval out of the allowable range to the number of times of measurement.

8. The extreme ultraviolet light generation apparatus according to claim 7,
wherein the processor stores, as the prohibited duty, the duty with which the droplet parameter is equal to or more than a second threshold value.

9. The extreme ultraviolet light generation apparatus according to claim 7,
wherein the processor calculates a center value of a region of the duty with which the droplet parameter is less than a second threshold value based on data indicating a relationship between the duty set while avoiding the prohibited duty and the droplet parameter, and sets the center value as the duty of the electric signal to be output to the piezoelectric element.

10. The extreme ultraviolet light generation apparatus according to claim 1,
wherein the processor deletes the prohibited duty after maintaining the prohibited duty for a predetermined time.

11. The extreme ultraviolet light generation apparatus according to claim 1,
wherein the processor determines the prohibited duty by acquiring the droplet parameter while generating the droplets with the setting of the duty changed without generating the extreme ultraviolet light, and stores the prohibited duty.

12. The extreme ultraviolet light generation apparatus according to claim 1,
wherein the processor acquires the droplet parameter while generating the extreme ultraviolet light with the setting of the duty changed while avoiding the prohibited duty, and performs the control of setting the duty based on the acquired droplet parameter.

13. The extreme ultraviolet light generation apparatus according to claim 1,
wherein the processor acquires the droplet parameter again with the duty set during the control, and updates the prohibited duty by adding a duty prohibited to be set to the prohibited duty based on the acquired droplet parameter.

14. A droplet generation control method in an extreme ultraviolet light generation apparatus configured to generate extreme ultraviolet light by irradiating droplets with laser light, the method comprising:
setting a duty representing a ratio of an on time in one cycle of an electric signal;
generating the droplets of a target substance by applying vibration reflecting the electric signal to the target substance to be output from a nozzle by applying the electric signal to a piezoelectric element;
measuring a temporal passage interval of the droplets by a timing sensor;
calculating a droplet parameter from the passage interval;
determining a prohibited duty that is the duty prohibited to be set based on data in which the duty and the droplet parameter with the duty are associated with each other; and
performing control of setting the duty of the electric signal based on the droplet parameter while avoiding the prohibited duty.

15. An electronic device manufacturing method, comprising:
generating extreme ultraviolet light using an extreme ultraviolet light generation apparatus;
outputting the extreme ultraviolet light to an exposure apparatus; and
exposing a photosensitive substrate to the extreme ultraviolet light in the exposure apparatus to manufacture an electronic device,
the extreme ultraviolet light generation apparatus including:
a tank configured to store a target substance in a liquid state;
a nozzle configured to output the target substance stored in the tank;
a piezoelectric element configured to apply vibration to the target substance to be output from the nozzle to generate the droplets of the target substance, the vibration reflecting an electric signal having a ratio of an on time in one cycle as a duty;
a timing sensor configured to measure a temporal passage interval of the droplets; and
a processor configured to:
output the electric signal to the piezoelectric element after setting the duty,
calculate a droplet parameter from the passage interval,
determine a prohibited duty that is the duty prohibited to be set based on data in which the duty and the droplet parameter with the duty are associated with each other, and
perform control of setting the duty of the electric signal based on the droplet parameter while avoiding the prohibited duty.

16. An electronic device manufacturing method, comprising:
generating extreme ultraviolet light using an extreme ultraviolet light generation apparatus;
inspecting a defect of a mask by irradiating the mask with the extreme ultraviolet light;
selecting a mask using a result of the inspection; and
exposing and transferring a pattern formed on the selected mask onto a photosensitive substrate, the extreme ultraviolet light generation apparatus including:
a tank configured to store a target substance in a liquid state;
a nozzle configured to output the target substance stored in the tank;
a piezoelectric element configured to apply vibration to the target substance to be output from the nozzle to generate the droplets of the target substance, the vibration reflecting an electric signal having a ratio of an on time in one cycle as a duty;
a timing sensor configured to measure a temporal passage interval of the droplets; and
a processor configured to:
output the electric signal to the piezoelectric element after setting the duty,
calculate a parameter droplet from the passage interval,
determine a prohibited duty that is the duty prohibited to be set based on data in which the duty and the droplet parameter with the duty are associated with each other, and
perform control of setting the duty of the electric signal based on the droplet parameter while avoiding the prohibited duty.
